(19) United States
(12) Patent Application Publication
(10) Pub. No.: US 2002/0178090 A1
(43) Pub. Date: Nov. 28, 2002

(54) Method and apparatus to obtain service businesses to assist in solving a trouble

(76) Inventor: Henry A. Dahut, Valley Village, CA (US)

Correspondence Address: Jack C. Munro, 28720 Roadside Drive, Suite 225, Agoura Hills, CA, 91301, US

(21) Appl. No.: 09/862,100

(22) Filed: May 22, 2001

(51) Int. Cl. G06F 17/60

(52) U.S. Cl. 705/27; 705/1

(57) ABSTRACT

A method and apparatus of using a computer monitor in conjunction with a remote memory device to select a major event. Upon selection of the major event, a series of specific events which are related to the major event are then displayed. The selector then selects a single specific event which causes a series of sub-events to be displayed which are related to the specific event. The selector then makes a limitation to a localized geographical area which will affect further selections. Displaying on the computer monitor a plurality of service oriented businesses to the selector that are located within or adjacent to the selected geographical area with the selector then being able to extract contact information on a particular business with the selector to then use that information to contact that particular business and achieve assistance concerning the major event.

### BACKGROUND OF THE INVENTION

1. Field of the Invention

The field of this invention relates generally to a method and system for obtaining contact information for service oriented businesses in order to assist individuals in solving a serious trouble or troubles having to do with a major event.

2. Description of the Related Art

It seems that one of the things that is ever present in peoples lives is serious trouble which is the type of trouble that is by it's nature profoundly disruptive. It summons the immediate need to obtain both information and resources that can solve the trouble. Trouble can come in a wide variety of events. The major events can be said to fall under four categories. The events are legal trouble, health trouble, financial trouble and romantic trouble. A major event, for our purposes, is defined as any life occurrence, which, by its nature, is both life changing and adverse to the person involved.

Within a major event such as legal trouble, there can be numerous specific events such as being arrested (criminal law), getting fired (employment), getting a divorce (family law), getting injured (personal injury law), etc. Under each of these specific events, there is a plurality of specific and general related information and resources that can help the individual in his or her time of trouble. For example, in the criminal event of getting arrested for drunk driving, there is often the need for a criminal defense lawyer, new car insurance, descriptions and locations of alcohol treatment centers, and the need to borrow money to pay for these unexpected expenses.

When one is going through trouble, one is usually left to his or her own devices. In the case of legal trouble, if one needs a lawyer, one can be found in a telephone directory. However, people rarely just need a lawyer. The process of finding a lawyer is not made in isolation—it is always within the context of some event, the type and severity of which, will dictate the resources required and the information they will need. For example, if the legal event has to do with the specific event of divorce, one will need more than just a divorce attorney. The event calls for much more. One of the spouses may be moving out, if so, there is the need for an apartment guide, perhaps furniture rental, a mover, a storage facility, a place to board the pet. Not only is there the need for service providers within the event, there is also the need for information that describes the event and the options available. For example, if the divorce involves custody issues, the matter of parental rights and the criteria for establishing parental custody is highly relevant information. Therefore, information concerning how to find a local family lawyer that specializes in custody issues will be useful.

Prior to designing and utilizing of the present invention, there has not been known a single source which integrates, by event, both relevant resources and information about a specific trouble while being directed to a local resource that aids in the solving of that trouble.

### SUMMARY OF THE INVENTION

One embodiment of this invention is that it provides listing(s) of resources, such that the user can acquire the services of individuals and businesses to assist in solving an event created trouble. This is achieved by viewing by a selector by means of a computer monitor a listed series of major events. The selector is to select a major event which transfers the selector to a series of specific events which are related to the major event. The selector is to then select a specific event which transfers the selector to a list of informational areas directly related to the specific event. The selector then selects an informational area which transfers the selector to a sub-event screen. When the selector makes a selection of a sub-event, a geographical area selection screen is displayed with the selector to select a localized geographical area which will affect further selections. The computer monitor then displays a plurality of service oriented businesses to the selector which are located within or adjacent to the geographical area with the selector able to extract contact information on a particular business with the selector to then use that information to contact that particular business and achieve assistance concerning the event created trouble.

Another embodiment of this invention comprises the selecting by the selector of a general information web site to inform the selector about the selected particular business.

Another embodiment of this invention comprises a system for obtaining at least one listing of services of a particular business to assist in solving a trouble. There is utilized a means for viewing a listed series of different major troubles and a means for selecting a particular major trouble which will then cause displaying of a series of specific troubles which are related to the major trouble. A specific trouble is then selected which transfers the selector to a list of informational areas directly related to the general specific trouble. An informational area is then selected which transfers the selector to a series of precisely specific troubles. There is a further means for limiting further selections to a localized geographical area. Lastly, there is included a means for displaying a plurality of particular businesses located with or adjacent to the geographical area with the selector able to extract contact information on a particular business with the selector to then use that information to contact that particular business and achieve assistance concerning the trouble.

In yet a still further embodiment of this invention, there is included a means for further selecting by the selector a general information web site to inform the selector about the particular business.

A system for obtaining at least one listing for business services to assist in solving a major trouble which utilizes a memory device which has embodied therein information relating to a plurality of particular businesses, a computer which is located remote from this memory device and is connected to the memory device is to be activated by a selector to display on a computer monitor a series of different major troubles with the selector then to select one of these major troubles which then will immediately cause the displaying a series of specific troubles which are related to the major trouble. The computer monitor then displays a series of specific events and upon selecting a specific event a list of informational areas are displayed which are related to the specific event. The computer monitor then displays a sub-event screen upon selection of a specific informational area. The computer monitor then displays an output requesting the selector to choose a localized geographical area. Upon selection of the geographical area by the selector, the computer then displays a plurality of particular businesses located within or adjacent to the selected localized geographical area with the selector to then be able to extract contact information on the special particular business with the selector to then use that information to contact the particular business and achieve assistance concerning the trouble.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is an overall view of a selector and a personal computer which is to be utilized in conjunction with the method and system of this invention with the computer to be connected to the worldwide web or internet;

FIG. 2 is the major events screen that is brought up when first logging onto the web site comprising the method and system of this invention;

FIG. 3 depicts a specific event screen;

FIG. 4 depicts a sub-event screen;

FIG. 5 depicts a specific sub-event screen;

FIG. 6 is a screen that is then displayed to the selector permitting the selector to select a localized geographical area;

FIG. 7 is a screen displaying a listing of service oriented businesses which are geared to deal with the event created trouble that was originally selected by the selector; and

FIG. 8 is a general representation of a web site for a professional practitioner such as an attorney.

### DETAILED DESCRIPTION OF THE INVENTION

Referring particularly to FIG. 1 of the drawings, there is shown a user or selector 10 who is located in front of a computer 12, computer monitor 14, keyboard 16 and mouse 18. Mouse 18 is located on a mouse pad 20. The computer 12, computer monitor 14, keyboard 16, mouse 18 and mouse pad 20 are located on a table 22. The computer 12 is to be connected to the worldwide web or internet 24. Let it be assumed that the selector 10 has encountered one of the many troubles that occur to people in life and has inputted, by means of the keyboard 16 in the computer 12, a web site address. This web site address is GotTrouble.com.

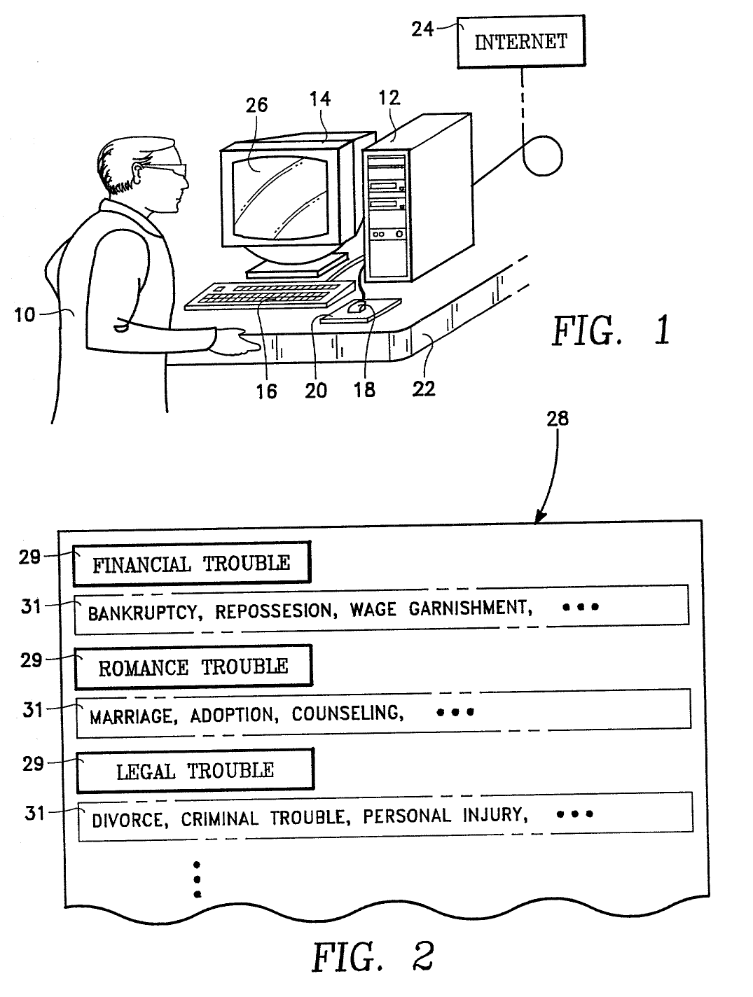

After inputting the web site address into the computer 12, there will be displayed a list 28 of major events 29. By way of example, this list is shown in FIG. 2 with the different major events 29 being defined as legal trouble, financial trouble, health trouble and romance trouble. However, it is considered to be within the scope of this invention that other major events 29 could be listed. It is to be understood that each major event 29 is generic and defines a general class of trouble within the bounds of trouble with each class of trouble generally being separated but relevant to each other class. Under each major event 29 is a box 31 which lists specific troubles having to do with the major event. The selector could directly click on one of these troubles in box 31 which will result in displaying a specific event screen for that trouble.

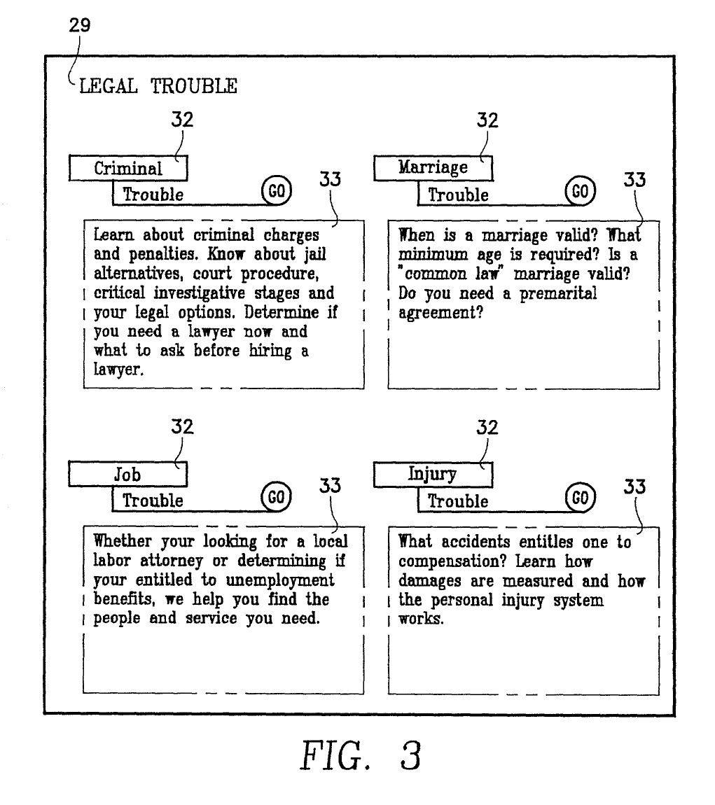

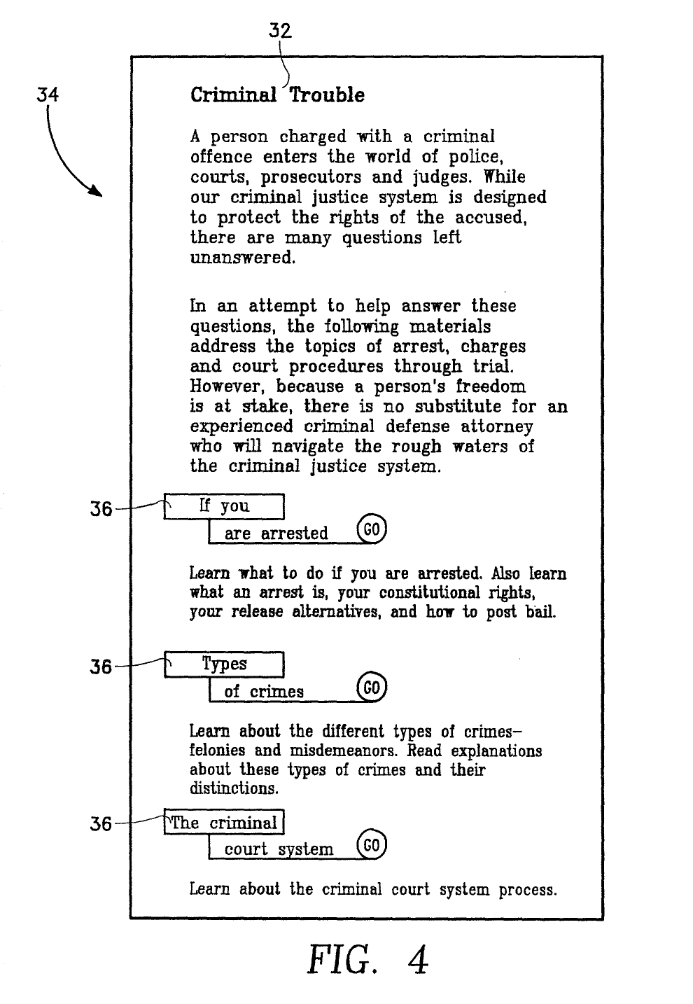

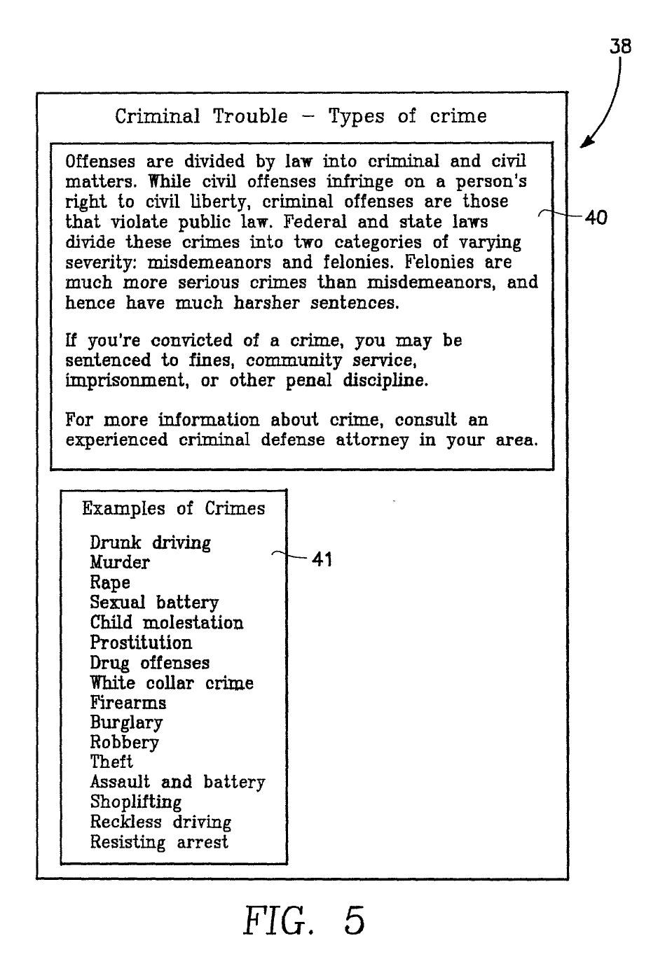

Let is be assumed that the selector 10 selects legal trouble. This selection is shown in FIG. 3. There will be automatically displayed a screen 30 which includes a plurality of specific events 32. Those specific events are marriage trouble, criminal trouble, debt trouble, injury trouble, job trouble, landlord trouble, consumer trouble, immigration trouble, estate trouble and tax trouble. However, it is to be understood that there may be a great number of additional specific events 32. Each of the specific events 32 are under the umbrella of legal trouble 29. Under each specific event 32 there is a general description box 33 informing the user of some general information concerning that specific event. Let it now be assumed that the selector 10 has a trouble having to do with criminal trouble. The selector 10 then selects the specific event 32 of criminal trouble. This in turn will cause a screen 34 to be displayed which includes a plurality of informational areas 36. These informational areas are if you are arrested, types of crimes, the criminal court system and find a defense lawyer. However, it is considered to be within the scope of this invention that numerous other informational areas 36 could be listed.

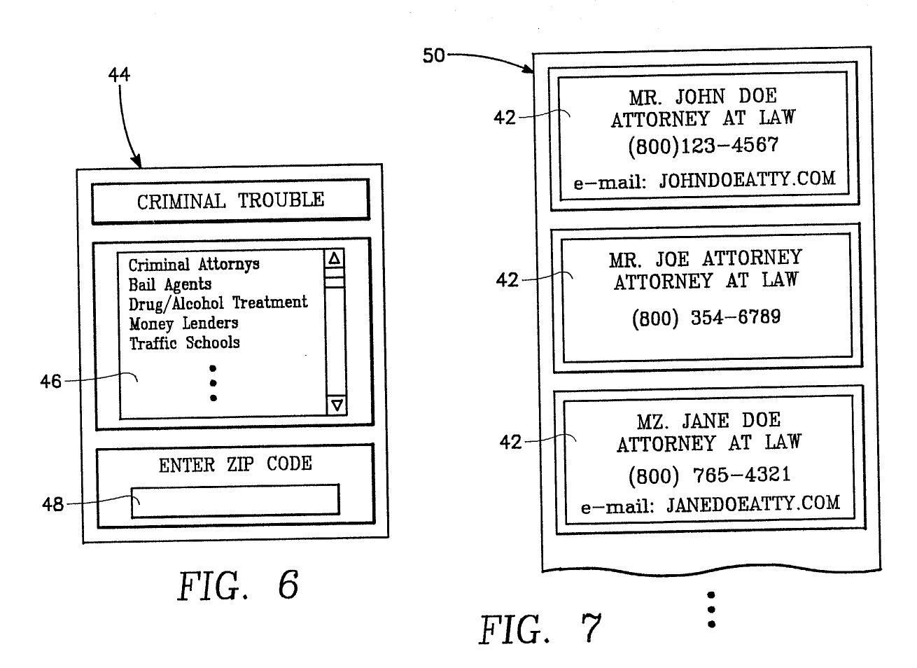

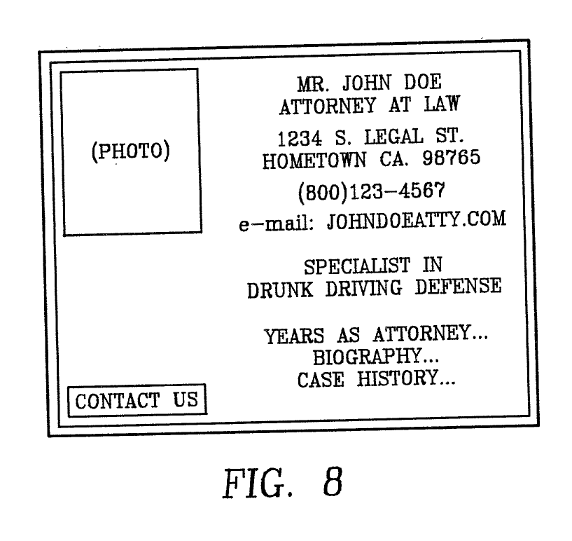

It is important to note that each of the specific events 32 are all under the umbrella of legal trouble which is a major event 29 within the list 28. Also, under the specific event 32 of criminal trouble, each of the informational areas 36 have to do with the specific event 32 of criminal trouble. Let it be assumed that the selector 28 has selected types of crimes as an informational area 36. There will then be displayed a sub-event screen 38. This screen 38 will provide some general information in box 40 about types of crimes and then give a list 41 of examples of crimes. Upon making an election of a specific crime from list 41, there will be displayed a geographical screen 44 which is shown in FIG. 6. This geographical screen 44 will require the selector 10 select a particular resource such as criminal attorney, bail agents, drug and alcohol treatment, money lenders or traffic schools and possibly other listed related resources. The selector then inputs the particular state in box 46 or the particular zip code in box 48 which is of concern to the selector 10. There will now be displayed a screen 50 in FIG. 7 which will be divided into a plurality of business listings 42 corresponding to the selected resource. The selector 10 can then observe each of the business listings 42 and make a selection. Let it be assumed that the selector 10 clicks on Mr. John Doe, Attorney at Law business listing. This will now cause the web site, shown generally in FIG. 8, for Mr. John Doe Attorney at Law to be displayed. The selector 10, upon reading of the information on the web site for Mr. John Doe, can then make a determination as to whether the selector 10 wishes to contact Mr. John Doe toward possibly retaining the services of Mr. John Doe in order to solve his or her specific trouble which is precisely represented by means of the specific sub-event 38.

Each specific sub-event 38 is directly related to the selected specific event 32. The user may end up actually selecting two or more specific sub-events 38. For example, even though the selector 10 selected types of crimes, the selector 10 could also select “if you are arrested” or “the criminal court system” as also being subjects being involved with criminal trouble.

The number one reason why people go on-line is for information. The subject matter of this invention is designed to be a single concise location for any selector 10 to obtain information regarding the major event which is shown on the screen 28.

GotTrouble.com is the first electronic directory devoted exclusively for people facing life's serious troubles. Unlike the current clutter of general-scope search engines, delivering torrents of unrelated digital text, GotTrouble.com delivers highly targeted context rich information based on the actual trouble the person is experiencing.

By focusing on the specific needs of a life-changing event, GotTrouble.com anticipates a searchers needs and delivers critical and time sensitive information, services and products at a local level.

GotTrouble.com has developed a unique site architecture and search engine submission process designed to produce high levels of site traffic. Developed under the name PODS, it stands for Porta Optimization Delivery Systems. GotTrouble.com site architecture is, in essence, the sum total of its PODS. By example, we have seen that the major event of legal trouble, is itself made up of many specific units of information and resources. These specific units of information and resources are called PODS but are also separate self-contained web sites. These web sites are themselves modeled after the event it describes. When such POD's or web sites are submitted to search engines under their respective event descriptions which are key word driven (i.e., divorce, pharmacies, etc.) search engines examine and rank them according to the sites relevancy and the depth of its resources. Since the POD contains by its nature, high levels of relevant content and resources, search engines assign them high rankings within their engine. The higher the rankings, the higher the traffic the POD will receive. The higher the traffic the POD receives, the more traffic the overall site receives. This is because, as stated above, GotTrouble.com is itself made up of the sum of its parts.

GotTrouble.com is the only resource that combines context-rich event related content with local resources. GotTrouble.com is easily distinguishable from the phone book. The phone book is a one-dimensional directory listing hundreds of attorneys alphabetically (not by event) and by region. Phone books neither offer content nor do they integrate resources. GotTouble.com permits the user to obtain the desired information and related resources by event—not solely by alphabetical order or region. GotTouble.com provides the person in trouble with a one-stop source for information and local resources. Search engines favor sites that possess deep levels of content with interrelated linkage.

The present invention may be embodied in other specific forms without departing from the essential attributes thereof. Reference should be made to the appending claims rather than the foregoing specification as indicating the scope of the invention.

What is claimed is:

1. A method of obtaining listings on the basis of inputting an event created trouble for which one is seeking a solution, said method for acquiring services of certain individuals to assist in solving a said event created trouble, said method comprising the steps of:
viewing by a selector by means of a computer monitor a series of major events;
selecting a said major event which transfers the selector to a series of specific events which are related to the major event;
selecting a said specific event which transfers the selector to a list of informational areas directly related to said specific event;
making a selection within the sub-event screen which requires the selector to limit further selections to a localized geographical area;
selecting a said informational area which transfers the selector to a sub-event screen; and
displaying a plurality of service oriented businesses to the selector located within or adjacent to said geographical area with the selector able to extract contact information on a particular business with the selector to then use that information to contact the particular business and achieve assistance concerning the event created trouble.

2. The method as defined in claim 1 wherein after the displaying step there is the following step:
further selecting by the selector of a general information web site to inform the selector about the selected particular business.

3. A system for obtaining at least one listing of services of a particular business to assist in solving a trouble comprising:
means for viewing a listed series of different major troubles;
means for selecting a said major trouble which displays a series of general specific troubles which are related to the major trouble;
selecting a said general specific trouble which transfers the selector to a list of informational areas directly related to said general specific trouble;
selecting a said informational area which transfers the selector to a series of precisely specific troubles;
means for limiting further selections to a localized geographical area; and
means for displaying a plurality of said particular services located within or adjacent to said geographical area with a selector able to extract contact information on a said particular business with the selector to then use that information to contact said particular business and achieve assistance concerning the trouble.

4. The system as defined in claim 3 including:
means for further selecting by the selector a general information web site to inform the selector about the particular business.

5. A system for obtaining at least one listing of business services to assist in solving of a major trouble comprising:
a memory device having embodied therein information relating to a plurality of particular businesses;
a computer located remote from said memory device, said computer being connected to said memory device, said computer to be activated by a selector to display on a computer monitor a series of different major troubles with the selector then to select a said major trouble which then displays a series of specific troubles which are related to the major trouble;
said computer monitor then displaying a series of specific events and upon selecting of one said specific event displays a list of informational areas directly related to said specific event;
said computer monitor then displaying a sub-event screen upon selection of a specific informational area;
said computer monitor then displaying an output requesting the selector to choose a localized geographical area; and
said computer monitor then displaying a plurality of said particular businesses located within or adjacent to said selected localized geographical area with said selector to then be able to extract contact information on a said particular business with the selector to then use that information to contact said particular business and achieve assistance concerning the trouble.
